(19) United States
(12) Patent Application Publication
(10) Pub. No.: US 2020/0346784 A1
(43) Pub. Date: Nov. 5, 2020

(54) ARM ASSEMBLY AND UNMANNED AERIAL VEHICLE

(71) Applicant: SZ DJI TECHNOLOGY CO., LTD., Shenzhen (CN)

(72) Inventors: Chaofan GUO, Shenzhen (CN); Yin TANG, Shenzhen (CN)

(21) Appl. No.: 16/931,239

(22) Filed: Jul. 16, 2020

Related U.S. Application Data
(63) Continuation of application No. PCT/CN2018/073432, filed on Jan. 19, 2018.

(51) Int. Cl. B64D 47/02; B64C 1/06

(52) U.S. Cl. CPC B64D 47/02; B64C 39/024; B64C 1/063

(57) ABSTRACT

An unmanned aerial vehicle (UAV) includes a vehicle body and an arm assembly. The vehicle body includes a distribution board. The arm assembly includes an arm body, a lampshade, and an electric speed control (ESC) light control board. The arm body includes an accommodation space. The lampshade is mounted at the arm body. The ESC light control board is arranged in the accommodation space and electrically connected to the distribution board through a wire. The ESC light control board includes an illuminator corresponding to the lampshade and is configured to emit light out of the arm assembly through the lampshade.

### CROSS-REFERENCE TO RELATED APPLICATION

This application is a continuation of International Application No. PCT/CN2018/073432, filed Jan. 19, 2018, the entire content of which is incorporated herein by reference.

### TECHNICAL FIELD

The present disclosure generally relates to the unmanned aerial vehicle (UAV) field and, more particularly, to an arm assembly and a UAV.

### BACKGROUND

In the existing technology, an unmanned aerial vehicle (UAV) is provided with an electric speed control (ESC) board and an indicator board connected to the ESC board. The indicator board is mounted at an arm of the UAV. The ESC board is integrated at a mainboard of the UAV. During a flight or commissioning phase of the UAV, an indicator of the indicator board emits corresponding light signals according to different operating conditions. A lampshade corresponding to the indicator is provided at the arm of the UAV. The light signals can be transmitted to the outside of the arm through the lampshade, and the operator can observe the light signals through the lampshade.

Since all the ESC boards are integrated at the mainboard, once one of the ESC boards or the mainboard has a failure or is damaged, the mainboard needs to be disassembled and repaired, and the repair cost is high. Moreover, troubleshooting and mainboard repair are difficult and take a long time, which leads to long waste idle time for the UAV and seriously affects the use efficiency. The ESC board and the indicator board are arranged individually and need to be produced separately, and the manufacturing cost is high.

### SUMMARY

In accordance with the present disclosure, there is provided an unmanned aerial vehicle (UAV) including a vehicle body and an arm assembly. The vehicle body includes a distribution board. The arm assembly includes an arm body, a lampshade, and an electric speed control (ESC) light control board. The arm body includes an accommodation space. The lampshade is mounted at the arm body. The ESC light control board is arranged in the accommodation space and electrically connected to the distribution board through a wire. The ESC light control board includes an illuminator corresponding to the lampshade and is configured to emit light out of the arm assembly through the lampshade.

In accordance with the present disclosure, there is provided an unmanned aerial vehicle (UAV) including a vehicle body, an arm body, a lampshade, and an electric speed control (ESC) light control board. The vehicle body includes a distribution board. The arm body is rotatably connected to the vehicle body and defines an accommodation space. The lampshade is mounted at the arm body. The electric speed control (ESC) light control board is arranged in the accommodation space and electrically connected to the distribution board through a wire. The ESC light control board includes an illuminator corresponding to the lampshade and is configured to emit light out of the arm assembly through the lampshade.

In accordance with the present disclosure, there is provided an unmanned aerial vehicle (UAV) including a vehicle body, an arm body, a lampshade, and an electric speed control (ESC) light control board. The vehicle body includes a distribution board. The arm body is connected to the vehicle body and defines an accommodation space. The electric motor is arranged at a free end of the arm body. The lampshade is mounted at the arm body. The electric speed control (ESC) light control board is arranged in the accommodation space and electrically connected to the distribution board and the electric motor. The ESC light control board includes an illuminator corresponding to the lampshade and is configured to emit light out of the arm assembly through the lampshade. The ESC light control board is configured to control the electric motor to operate according to a control signal output by the distribution board and control at least one illuminator to emit a corresponding light signal.

### BRIEF DESCRIPTION OF THE DRAWINGS

FIG. 1 illustrates a schematic structural diagram of an unmanned aerial vehicle (UAV) according to some embodiments of the present disclosure.

FIG. 2 illustrates a schematic structural diagram of the UAV with with a body in an opened state according to some embodiments of the present disclosure.

FIG. 3 illustrates a schematic assembly diagram of an arm assembly and the body according to some embodiments of the present disclosure.

FIG. 4 illustrates a schematic internal structural diagram of the arm assembly according to some embodiments of the present disclosure.

FIG. 5 illustrates a schematic assembly structural diagram of a lampshade and an electric speed control (ESC) light control board according to some embodiments of the present disclosure.

Reference numeral:

| | | |
|---|---|---|
| Arm body 10 | Bottom surface 11 | Sidewall surface 12 |
| Body connection | Wiring slot 14 | Openning part 15 |
| member 13 | | |
| Guide hole 151 | Protrusion rib 152 | Electric-motor- |
| | | mounting base 16 |
| Openning 17 | ESC light control | Illuminator 21 |
| | board 20 | |
| Circuit board 22 | Lampshade 30 | Light guide 31 |
| Arced protrusion 311 | Shade body 32 | Snap member 33 |
| Cover body 40 | Electric motor 50 | Landing stand 60 |
| Wire 70 | Arm assembly 100 | Body 200 |
| Distribution board 201 | Mounting slot 202 | |

### DETAILED DESCRIPTION OF THE EMBODIMENTS

Technical solutions in embodiments of the present disclosure are described in connection with accompanying drawings in embodiments of the present disclosure. The described embodiments are only some embodiments not all the embodiments of the present disclosure. Based on the embodiments of the disclosure, all other embodiments obtained by those of ordinary skill in the art without any creative work are within the scope of the present disclosure.

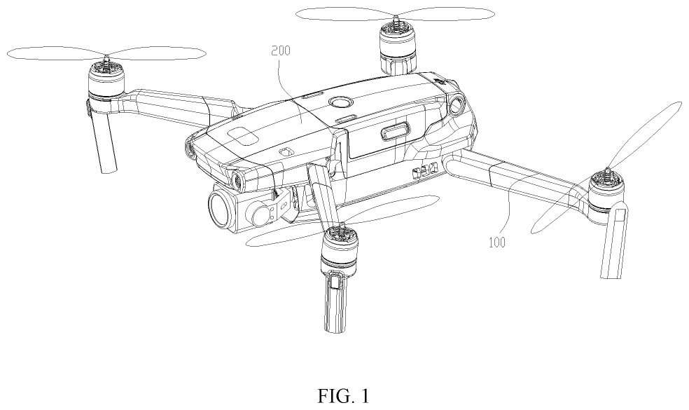

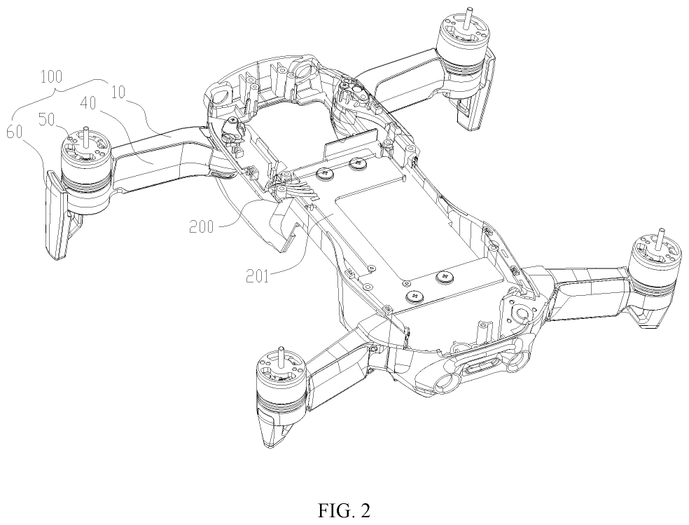

As shown in FIG. 1 and FIG. 2, an unmanned aerial vehicle (UAV) includes a body 200 (also referred to as a “vehicle body”) and an arm assembly 100 arranged at the body 200. The arm assembly 100 includes an arm body 10, an electric speed control (ESC) light control board 20 arranged at the arm assembly 10, and a lampshade 30 mounted at the arm body 10. The arm assembly 100 further includes an electric motor 50 arranged at a free end of the arm body 10. The electric motor 50 is electrically connected to the ESC light control board 20. The arm body 10 may be formed integrally with the body 200 or detachably mounted at the body 200. The arm body 10 is provided with an accommodation space. The ESC light control board 20 is fixed in the accommodation space. The body 200 is provided with a distribution board 201. The ESC light control board 20 is electrically connected to the distribution board 201 through a wire 70.

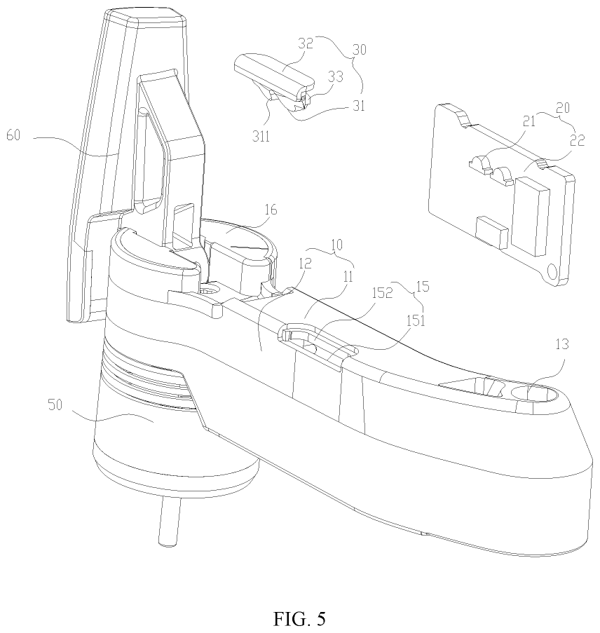

As shown in FIG. 5, the ESC light control board 20 is mounted in the arm body 10. The ESC light control board 20 includes a circuit board 22, control elements arranged at the circuit board 22, and at least one illuminator 21 configured to emit a light signal. The ESC light control board 20 controls the electric motor 50 to operate according to a control signal output by the distribution board 201 and controls at least one illuminator 21 to emit a corresponding light signal. The at least one illuminator 21 corresponds to a position of the lampshade 30 mounted at the arm body 10. The lampshade 10 is formed of a transparent material. The at least one illuminator 21 emits light and transmits the light to outside through the lampshade 30. In some embodiments, the at least one illuminator 21 is integrated at the ESC light control board 20 to simplify the structure of a light board and reduce the cost, and hence a degree of functional integration is high.

The arm body 10 is provided with an accommodation space, which may reduce the weight of the arm assembly 100 as a whole to realize a lightweight design of the arm assembly 100 of the UAV. The ESC light control board 20 is mounted in the accommodation space to fully utilize an inner space of the UAV. The ESC light control board 20 and the distribution board 201 are both heat-generating components. The ESC light control board 20 is arranged in the arm assembly 10, and the distribution board 201 is arranged in the body 200, such that heat-generating sources are separated and a heat dissipation effect of the UAV as a whole is improved. At the same time, the ESC light control board 20 and the distribution board 201 are provided as two individual components and are electrically connected through the wire 70 to transmit signals and electric power. Thus, the ESC light control board 20 and the distribution board 201 are connected conveniently, and the layout is more flexible. When one of the ESC light control board 20 and the distribution board 201 is damaged or fails, only the damaged one of them needs to be replaced. Thus, the maintenance cost is low, and continuous operation time of the UAV is long.

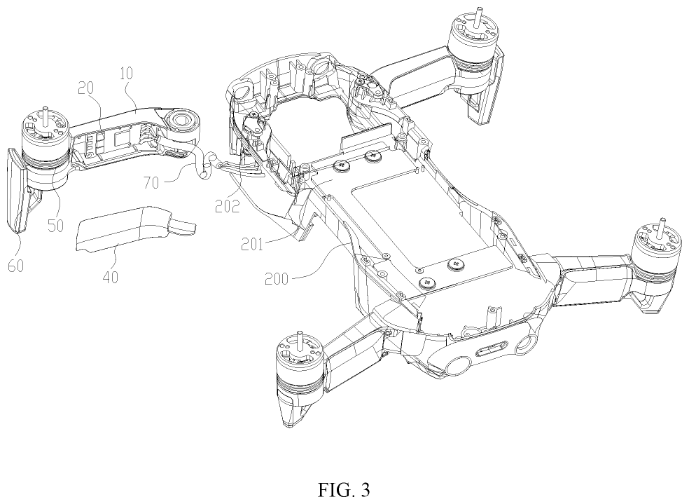

As shown in FIG. 2 and FIG. 3, the arm assembly 100 further includes an electric-motor-mounting base 16 arranged at the free end of the arm body 10. The electric motor 50 is mounted at the electric-motor-mounting base 16. The electric-motor-mounting base 16 is provided with a wire hole communicating with the accommodation space of the arm assembly 10. The wire hole is provided for the wire 70 electrically connected to the ESC light control board 20 to pass through. The electric-motor-mounting base 16 is arranged at the free end of the arm body 10. The electric-motor-mounting base 16 and the arm body 10 may be fixedly connected through a fastener or locking structure or formed integrally. In some embodiments, the electric-motor-mounting base 16 and the arm body 10 are formed integrally.

The wire 70 passes through the wire hole to enter the electric-motor-mounting base 16 and are electrically connected to the electric motor 50. After the wire 70 is electrically connected to the electric motor 50, the electric motor 50 is fixed at the electric-motor-mounting base 16 to cause the wire 70 and the connection member of the electric motor 50 to be located in an enclosed space. The electric motor 50 is electrically connected to the ESC light control board 20, which is convenient to mount and safe. The electric-motor-mounting base 16 and the arm body 10 are formed integrally, which are convenient to process and have a good consistency.

In some embodiments, an end of the arm body 10 away from the electric-motor-mounting base 16 is provided with a body connection member 13, which may be detachably connected to the body 200 of the UAV. That is, the body connection member 13 and the electric-motor-mounting base 16 are located at two ends of the arm body 10, respectively. The body 200 is provided with a mounting slot 202. The body connection member 13 is inserted in the mounting slot 202 and locks the arm assembly 100 at the body 200 through a fastener or a pin. For example, an axis hole is arranged at the body 200 penetrating the mounting slot 202. A connection axis passes through the axis hole and the body connection member 13 to mount the arm assembly 100 at the body 200. In some embodiments, the body connection member 13 may include a rotatable connection member, such that the arm body 10 may rotatably be connected to the body 200. The arm body 10 may rotate about the connection axis to fold the electric motor 50 and the arm body 10 towards an outer side of the body 200 or unfold the electric motor 50 and the arm body 10 to be in a flight configuration.

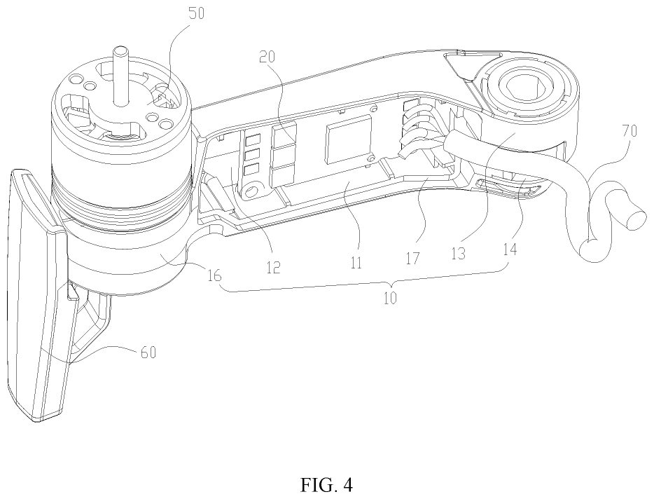

As shown in FIG. 3 and FIG. 4, the ESC light control board 20 is arranged in the accommodation space of the arm body 10. The body connection member 13 is provided with a wire slot 14 communicating with the accommodation space, and the wire slot 14 is configured for the wire 70 electrically connected to the ESC light control board 20 to pass through. An end of the wire 70 passes through the wire slot 14 to extend into the accommodation space to be connected to the ESC light control board 20. The other end of the wire 70 extends into the body 200 to be connected to the distribution board 201. The arm assembly 100 may be detachably mounted at the body 200 or rotatably connected to the body 200. The ESC light control board 20 is connected to the distribution board 201 through the wire 70, which may be adjusted flexibly according to connection methods of the arm assembly 100 and the body 200 to transmit the signals in time between the ESC light control board 20 and the distribution board 201. Thus, control is convenient. The wire 70 is configured to transmit at least one signal of a power source signal, a flight throttle signal, an indicator control signal, or an ESC status feedback signal.

The arm assembly 100 is detachably connected to the body 200, which may improve assembly efficiency. When the ESC light control board 20 or the electric motor 50 mounted at the arm body 10 has a failure, the arm assembly 100 may be replaced as a whole to improve the continuous flight time of the UAV. In some embodiments, after the wire 70 is removed, the ESC light control board 20 or the electric motor 50 may be replaced. Thus, replacement efficiency is high, and the replacement cost is low.

The arm body 10 includes a mounting hole arranged at an inner side surface of the accommodation space. The ESC light control board 20 is fixed at the mounting hole through a fastener. In some embodiments, when the UAV is in horizontal flight status, the ESC light control board 20 is vertically located in the accommodation space. The ESC light control board 20 is fixed at the mounting hole through the fastener. An interval space is formed between the inner side surfaces of the accommodation space. The illuminator 21 is arranged at the circuit board 22 and located in the interval space. A volume of the interval space is small, and the interval space absorbs a small amount of light emitted by the illuminator 21, such that the light emitted by the illuminator 21 may be transmitted through the lampshade 30 to improve the brightness of the lampshade 30. The ESC light control board 20 is mounted vertically in the accommodation space. An assembly process has a high degree of visibility, thus the complexity of assembly is reduced, and a cooperation position of the illuminator 21 and the lampshade 30 may easily be adjusted.

In some embodiments, the arm body 10 is provided with an opening 17 communicating with the accommodation space. The ESC light control board 20 enters the accommodation space from the opening 17 and is fixed at the mounting hole through the fastener. The arm assembly 100 further includes a cover body 40, which covers the opening 17 and is detachably connected to the arm body 10. In some embodiments, the opening 17 is arranged at a side surface of the arm body 10. For example, when the arm assembly 100 is rotatably connected to the body 200, the opening 17 is located at a side of the arm body 10 that will be against a side of the body 200 when the arm body 10 rotates toward the side of the body 200.

After the ESC light control board 20 is mounted, the cover body 40 is arranged at the opening 17 to cause the ESC light control board 20 to operate in an enclosed environment, such that the ESC light control board 20 is subject to less external interference. After a failure of the ESC light control board 20 occurs, the cover body 40 is opened, and the ESC light control board 20 is detached from the wire 70. That is, the ESC light control board 20 or the arm assembly 100 may be removed from the body 200, which is convenient for the replacement of the ESC light control board 20 and dismounting and mounting operation of the arm assembly 100.

As shown in FIG. 4 and FIG. 5, the lampshade 30 is mounted at the arm body 10 and is configured to guide light emitted from the at least one illuminator 21. In some embodiments, the lampshade 30 includes a light guide 31 inserted in the arm body 10 and a shade body 32 fit and attached to the outer side of the arm body 10. The light guide 31 is at least partially accommodated in the arm body 10 and close to the corresponding illuminator 21. The light emitted from the illuminator 21 enters the lampshade 30 along an end surface of the light guide 31 and is expanded to the shade body 32 through the light guide 31. Thus, light transmission efficiency is high, and diffusion uniformity of the lampshade 30 is good. The operator may observe changes of the light of the lampshade 30 from the outside to obtain the light signal output by the ESC light control board 20 through the illuminator 21, which is convenient to observe.

For example, two illuminators 21 spaced apart from each other are arranged at the ESC light control board 20. The two illuminators 21 output the light signals with, e.g., different lights, different flashing frequencies, etc., according to the control instructions of the ESC light control board 20. The illuminators 21 are located at one side of the circuit board 22 and face an inner side surface of the arm body 10. The light guide 31 is located between the inner side surface and the circuit board 22. The end surface of the light guide 31 extends toward the two illuminators 21 to cause the light emitted from the two illuminators 21 to focus on the light guide 31. In some embodiments, to enlarge the light reception area of the light guide 31, the end surface of the light guide 31 is provided with a curved surface. For example, the end surface of the light guide 31 is provided with a plurality of arced protrusions 311 protruding at intervals toward the illuminators 21. In some embodiments, the end surface of the light guide 31 is provided with two arced protrusions 311. The positions of and the spacing distance between the two arced protrusions 311 correspond to the positions of and the spacing distance between the two illuminators 21, and hence the light-receiving area of the lampshade 30 is enlarged and the loss of the light emitted from the illuminators 21 is reduced. As such, the output brightness of the lampshade 30 is improved.

The arm body 10 is provided with the accommodation space and the opening 17 communicating with the accommodation space. A cross-section of the accommodation space includes a “U” shape structure facing one side, similar to the opening 17. The arm body 10 includes a bottom surface 11, a sidewall surface 12, and a top surface. An opening part 15 is formed at the arm body 10 to cooperate with the lampshade 30. The lampshade 30 is in snapping cooperation with the opening part 15. In some embodiments, the opening part 15 may be arranged at a side of the arm body 10.

For example, the opening part 15 is arranged at the bottom surface 11 or an intersection between the bottom surface 11 and the sidewall surface 12. The lampshade 30 is partially inserted in the opening part 15 and is snapped with the opening part 15. The portion of the lampshade 30 that is inserted in the opening part 15 corresponds to the position of the at least one illuminator 21 at the ESC light control board 20 to guide the light emitted from the illuminator to be transmitted to the outside of the arm assembly 100.

During the flight of the UAV, the ESC light control board 20 is always at operating status and controls the illuminator 21 to output the corresponding light signals. The lampshade 30 is arranged at the bottom surface 11 or the intersection between the bottom surface 11 and the sidewall surface 12 to facilitate the operator to observe the light signals of the UAV and determine flight status of the UAV from the ground. The lampshade 30 is snap-connected to the arm body 10, such that both the lampshade 30 and the arm body 10 may be conveniently mounted and dismounted.

The lampshade 30 is snap-connected to the arm body 10. In some embodiments, the opening part 15 includes a guide hole 151 communicating with the accommodation space and a protrusion rib 152 arranged at the side surface of the guide hole 151. An extension direction of the guide hole 151 is parallel to the sidewall surface 12. The protrusion rib 152 is at the bottom surface 11 and protrudes in a direction perpendicular to the sidewall surface 12. A step structure is formed between the protrusion rib 152 and the bottom surface 11.

The lampshade 30 includes a snap member 33 arranged at and protruding from one side of the light guide 31. The snap member 33 is perpendicular to the light guide 31 or protrudes obliquely. A snap slot is formed between the snap member 33 and the shade body 32. The light guide 31 is inserted along the guide hole 151 until the protrusion rib 152 is snapped at a concave slot between the snap member 33 and the shade body 32. The shade body 32 is fitted and attached to the bottom surface 11 or simultaneously fitted and attached to the bottom surface 11 and the sidewall surface 12.

The light guide 31 is at least partially accommodated in the arm body 10. The snap member 33 is snap-connected to the arm body 10 and pulls the shade body 32 to be fitted and attached to the outer side surface of the arm body 10. The lampshade 30 and the arm body are tightly coupled. The lampshade 30 is snap-connected to the arm body 10, such that the assembly is convenient. The lampshade 30 is at least partially inserted in the guide hole 151 and snap-connected to the protrusion rib 152. The guide hole 151 guides the light guide 31 to move toward the illuminator 21 to have a good guide effect. The light guide 31 of the lampshade 30 is provided with a step. When the lampshade 30 is inserted into the guide hole 151, one-step surface abuts against the end surface of the guide hole 151 at the sidewall surface 12. As such, the outer surface of the lampshade 30 is coplanar with the outer surface of the arm body 10, or the conjunction part between the lampshade 30 and the arm body 10 has a smooth transition, which improves the aesthetic of the arm assembly 100.

During landing of the UAV, the body 200 needs to be controlled to keep a predetermined distance away from the ground to protect the body 200. In some embodiments, the arm assembly 100 further includes a landing stand 60 located under the electric-motor-mounting base 16. The landing stand 60 extends from the electric-motor-mounting base 16 downward. During the landing of the UAV, the landing stand 60 abuts against the ground to support the body 200 away from the ground. As such, the support range is large, and the landing of the UAV is stable. The landing stand 60 is located under the electric-motor-mounting base 16 and is detachably connected to the electric-motor-mounting base 16. In some embodiments, the landing stand 60 may be rotatably connected to the electric-motor-mounting base 16, such that the landing stand 60 is folded to the electric-motor-mounting base 16 and close to the arm body 10. As such, packaging volume of the UAV during transportation is reduced.

The methods and devices provided by embodiments of the present disclosure are described in detail. The present disclosure describes the principles of the present disclosure and the implementations by using specific examples. The description of the above embodiments is merely used to help understand the method and core ideas of the present disclosure. For those of ordinary skill in the art, according to the ideas of the present disclosure, modifications may be made to specific implementations and application scope. In the case of no conflict, the above-described embodiments and features of embodiments can be combined with each other. In summary, the content of this specification should not be construed to limit the present disclosure.

What is claimed is:

1. An unmanned aerial vehicle (UAV) comprising:
a vehicle body including a distribution board; and
an arm assembly including:
an arm body including an accommodation space;
a lampshade mounted at the arm body; and
an electric speed control (ESC) light control board arranged in the accommodation space and electrically connected to the distribution board through a wire, the ESC light control board including an illuminator corresponding to the lampshade and configured to emit light out of the arm assembly through the lampshade.

2. The UAV of claim 1, wherein the arm body includes an opening part in snap-cooperation with the lampshade.

3. The UAV of claim 2, wherein the opening part is arranged at a side of the arm body.

4. The UAV of claim 2, wherein the opening part is arranged at a bottom surface of the arm body.

5. The UAV of claim 2, wherein:
the opening part includes a guide hole communicating with the accommodation space and a protrusion rib arranged at and protruding from a sidewall of the guide hole; and
the lampshade is at least partially inserted in the guide hole and snap-connected to the protrusion rib.

6. The UAV of claim 1, wherein:
the arm body includes a mounting hole arranged at a sidewall of the accommodation space; and
the ESC light control board is fixed at the mounting hole through a fastener.

7. The UAV of claim 1, wherein:
the arm assembly further includes an electric-motor-mounting base arranged at a free end of the arm body; and
the electric-motor-mounting base includes a wire hole communicating with the accommodation space of the arm body and configured for the wire to pass through.

8. The UAV of claim 7, wherein the electric-motor-mounting base and the arm body form an integral structure.

9. The UAV of claim 7, wherein the arm assembly further includes a body connection member at an end of the arm body away from the electric-motor-mounting base, the body connection member being detachably connected to the vehicle body.

10. The UAV of claim 9, wherein the body connection member includes a rotatable connection member configured to rotatably connect the arm body to the vehicle body.

11. The UAV of claim 9, wherein the body connection member includes a wire slot configured for the wire to pass through.

12. The UAV of claim 7, wherein the wire is configured to transmit at least one of a power source signal, a flight throttle signal, an indicator control signal, or an ESC status feedback signal.

13. The UAV of claim 7, wherein the arm assembly further includes a landing stand located under the electric-motor-mounting base.

14. The UAV of claim 1, wherein:
the arm body includes an opening communicating with the accommodation space; and
the arm assembly further includes a shade cover configured to enclose the opening and detachably connected to the arm body.

15. The UAV of claim 14, wherein the opening is arranged at a side of the arm body.

16. The UAV of claim 1, wherein the ESC light control board is mounted vertically in the accommodation space.

17. The UAV of claim 1, wherein:
the lampshade includes a light guide in the arm body and a shade body being fitted and attached to an outer side of the arm body; and
the light guide corresponds to the illuminator and is configured to guide the light emitted from the illuminator to the shade body.

18. The UAV of claim 17, wherein:
the light guide is at least partially accommodated in the arm body;
the lampshade includes a snap member arranged to protrude from one side of the light guide; and
the snap member is snap-connected to the arm body and configured to pull the shade body to be fitted and attached to an outer surface of the arm body.

19. An unmanned aerial vehicle (UAV) comprising:
a vehicle body including a distribution board; and
an arm body rotatably connected to the vehicle body and defining an accommodation space;
a lampshade mounted at the arm body; and
an electric speed control (ESC) light control board arranged in the accommodation space and electrically connected to the distribution board through a wire, the ESC light control board including an illuminator corresponding to the lampshade and configured to emit light out of the arm assembly through the lampshade.

20. An unmanned aerial vehicle (UAV) comprising:
a vehicle body including a distribution board; and
an arm body connected to the vehicle body and defining an accommodation space;
an electric motor arranged at a free end of the arm body,
a lampshade mounted at the arm body; and
an electric speed control (ESC) light control board arranged in the accommodation space and electrically connected to the distribution board and the electric motor, the ESC light control board including an illuminator corresponding to the lampshade and configured to emit light out of the arm assembly through the lampshade,
wherein the ESC light control board is configured to control the electric motor to operate according to a control signal output by the distribution board and control at least one illuminator to emit a corresponding light signal.
